(19) United States
(12) Patent Application Publication
(10) Pub. No.: US 2009/0320047 A1
(43) Pub. Date: Dec. 24, 2009

(54) Event Bundling

(75) Inventors: Furqan Khan, Alameda, CA (US); Rikard Kjellberg, Santa Cruz, CA (US)

Correspondence Address: FISH & RICHARDSON P.C., PO BOX 1022, MINNEAPOLIS, MN, 55440-1022, US

(73) Assignee: Ingboo Inc.

(21) Appl. No.: 12/488,337

(22) Filed: Jun. 19, 2009

Related U.S. Application Data
(60) Provisional application No. 61/074,985, filed on Jun. 23, 2008.

(51) Int. Cl. G06F 9/44

(52) U.S. Cl. 719/318

(57) ABSTRACT

Automatic bundling of related events is disclosed. The events can be drawn from disparate sources. Event bundling can remove the administrative burden from the person using a calendar system for task management and an email tool for alerts management. Event bundling can improve time management and enhance user productivity by automatically optimizing event scheduling, organizing information, and removing information clutter for the user. Event bundling can be achieved using context and time window bundling.

### CROSS-REFERENCE TO RELATED APPLICATION

This application claims the benefit of U.S. Provisional Application Ser. No. 61,074,985, filed on Jun. 23, 2008, the entire content of which is hereby incorporated by reference.

### BACKGROUND

In today's busy information age, people access and manage a variety of events such as appointments, tasks, special public events, important dates, and information alerts from various sources. These events compete for attention. Events such as appointments and tasks are assigned by the user to slots in calendars or task lists. Information alerts feed into the user's email inbox or popup on the user's computer desktop as they become available.

Current software tools such as calendars, task-list managers, and email applications allow a user to document and manage events. However, these tools are no more than record-keepers of the information, and lack the capability to intelligently identify and process the relationships between events. These tools are oblivious to the context, timing and historic user behaviors related to each event, and as a result are unable to automatically optimize the scheduling and delivery of events and their related events. For example, in conventional tools, scheduling of events is a manual and time-consuming process. The user has to specify when each event should be scheduled, and adjust the schedules to best utilize time and reduce inconvenience. For another example, information alerts can be filtered and funneled by user-specified filters in existing email tools. The delivery of information and information alerts, however, bear no relationship to the scheduling of events. The user has to manually locate the relevant information (e.g., traffic and weather information) prior to carrying out a scheduled task, even if the user already subscribes to such information.

### SUMMARY

Automatic bundling or consolidation of related events is disclosed. Events can be bundled even when the event information is drawn from disparate and independent sources. Automatic bundling can reduce the administrative burden of a user using a calendar system for task management and an email tool for information alert management. Automatic event bundling opens an opportunity for improved time management and enhances a user's productivity by automatically optimizing scheduling, and organizing information updates. Information alert bundling also helps to remove information clutter for the user. Event bundling can be achieved using a context and/or time window bundling process.

In one aspect, a computer-implemented method for bundling events includes: receiving a plurality of events, each event being associated with a target time, an attention window surrounding the target time, and a completion window following the target time; identifying, among the plurality of events, a subset of events that have overlapping attention windows; and consolidating the identified subset of events into an overlapping portion of the respective attention windows of the subset of events by shifting one or more of the respective target times of the identified subset of events.

In some implementations, the plurality of events are from a plurality of independent sources.

In some implementations, the plurality of events include fixed events having fixed target times and flexible events having movable target times within the flexible events' respective attention windows.

In some implementations, the plurality of events include information alerts, date alerts, tasks, and appointments, each having either a fixed target time or a moveable target time within the event's respective attention window.

In some implementations, each of the plurality of events is further associated with a respective event category, and identifying the subset of events further includes: identifying, among the plurality of events, the subset of events having overlapping attention windows and being associated with compatible event categories.

In some implementations, each of the plurality of events is further associated with a respective context, and identifying the subset of events further includes: identifying, among the plurality of events, the subset of events having overlapping attention windows and being associated with compatible contexts.

In some implementations, the respective context of each of the plurality of events includes location information for the event, and compatibility of events is based on the location information.

In some implementations, each of the plurality of events is further associated with a respective event category and a respective context, and at least some of the plurality of events are related events based on the events' respective event categories and contexts, and identifying the subset of events further includes: identifying, among the plurality of events, the subset of events having overlapping attention windows and being related events to one another.

In some implementations, a pair of related events includes an outdoor task and a weather information alert, or an off-location task and a traffic information alert.

In some implementations, the method further includes: presenting, at a time prior to the respective target times of all of the subset of events, a listing of the consolidated subset of events as a scheduling recommendation to a user; and receiving user input accepting or rejecting the scheduling recommendation.

In some implementations, the method further includes: presenting, at a time prior to the respective target times of all of the subset of events, a listing of the consolidated subset of events as a scheduling recommendation to two related users; receiving user input accepting or rejecting one or more of the subset of events in the scheduling recommendation; and adjusting the consolidated subset of events for each of the two users based on the user input.

In some implementations, the method further includes: presenting a listing of the consolidated subset of events as a single task message on a display device.

In some implementations, the subset of events include flexible information alerts, and a listing of the consolidated subset of flexible information alerts are presented as a single information alert message.

Computer-readable media and systems implementing various aspects of the event bundling techniques are also disclosed.

In various implementations, the disclosed techniques may offer one or more of the following advantages. Multiple disparate schedules, task-lists and information alerts can be correlated for the purpose of identifying events that can be combined (bundled) into one time window. By bundling events, a person can better schedule his/her time without having to proactively examine and coordinate manually. By assigning an event type, priority, context (e.g., location), attention time window, and completion window to each event, the system can intelligently make event bundling decisions. Multiple users can interact with the same event bundling process to coordinate scheduling of events among themselves. Flexible information alerts can be bundled and presented to a user at a more appropriate time to reduce the barrage of information alerts at times when such information alerts are non-critical to the user.

Details of one or more implementations of the event bundling techniques are set forth in the accompanying drawings and the description below. Other features, objects, and advantages of the invention will be apparent from the description and drawings, and from the claims.

### DESCRIPTION OF DRAWINGS

FIG. 1 is an example schematic diagram illustrating the flow of event information from multiple independent sources to contribute to an Event View.

FIG. 2 is an example schematic diagram illustrating the interaction between a user and an Event Engine regarding event bundling recommendations.

FIG. 3 is an example schematic diagram illustrating the operation of the Event Engine for real-time event bundling.

FIG. 4 is an example schematic diagram illustrating the process for organizing events into a timeline.

FIG. 5 is a flow chart illustrating an example process for identifying events with overlapping time windows.

FIG. 6 is a flow chart illustrating an example process for bundling events with weather information and traffic information.

FIG. 7 is a flow chart illustrating an example process for event bundling and delivery.

FIG. 8 is a schematic diagram of two generic computing devices.

Like reference symbols in the various drawings indicate like elements.

### DETAILED DESCRIPTION

The present specification describes a technique for bundling events originating from independent sources for presentation/delivery to a user. An event is defined as a notification of information that has relevance to a person or persons. For example, the notification can be in a form of a message or reminder about a scheduled appointment or an information update. The notification is typically made by a software application or component on a computing device. Examples of a computing device include a mobile phone, a handheld device, a desktop computer, a laptop computer, and so on. Events fall into one of two types: scheduled events and unscheduled events. Examples of scheduled events can include notifications or reminders about birthdays, holidays, appointments, tasks (e.g., assignments, chores, etc.). Examples of unscheduled events can include news alerts, weather alerts, stock alerts, traffic alerts, and so on.

Scheduled or unscheduled, events are ultimately associated with a date and a time (e.g., a target time). In the case of unscheduled events, the date and the time can be assigned to the events as the events occur.

In addition, events can be further categorized as either fixed events or flexible events. Fixed events cannot be moved in time. A fixed event has a time window of zero duration before and after its specified date and time. Flexible events, on the other hand, can be moved within a specified time window.

An Event View is a listing of important and/or active events. The Event View is a view into an Event Attention Queue where prioritized events are stored and prepared for viewing. The Event View can be implemented as a message, a listing, or an alert window presented to a user. For example, the Event View can be presented to the user on a display device as a popup window when an update in the Event View occurs (e.g., when an event becomes active). The Event View can also be a message window listing one or more sets of bundled events.

Each event can be associated with a set attributes, e.g., the event attention criteria. This set of attributes can be used to filter active events for ordered placement of the event into the Event Attention Queue.

An Event Engine can be used to match and deliver events to a user based on the Event Attention Criteria. The Event Attention Criteria can be user-specific and/or user-defined.

A user can subscribe to all kinds of events from different sources and the Event View can include all subscribed events. For example, a user can subscribe to information alerts published by various sources, such as newsgroups, news feed via Real Simple Syndication (RSS), deal alerts, weather alerts, stock alerts, job alerts, traffic alerts, and so on. These information alerts can originate from independent information sources, such as websites, news servers, business partners, and so on. Each of these information sources can deliver emails, SMS, or information pop-ups to the user regularly, on a schedule, or at any time when new information becomes available. Other examples of events can include predefined scheduled events, such as national/ethic/religious holidays. These predefined scheduled events can be entered in a calendar tool by vendors of the calendar tool. A user can also supply important dates and appointments to the event pool directly. Important dates can include birthdays, anniversaries, assignment deadlines, and so on. Appointments can include meetings, visits, and examinations that a user has made a commitment to attend at a particular time and location. A user can also supply tasks (e.g., assignments, chores, obligations, exercise) that need to be completed within a time window or before a deadline. An external system (e.g., a network device) can also supply important dates, appointments, and tasks to the event pool. For example, a user can allow an assistant, a supervisor, a business associate, a doctor, and/or a mechanic to enter important date, appointments, assignments, tasks, an invitation to a social gathering, and so on, into the event pool.

The events in the event pool can come from many independent sources and they can be delivered to the user via the Event View. When an event becomes active (e.g., a news alert arrives and/or oil change appointment is coming up within a predetermined period), the event is filtered according to its Event Attention Criteria. Events that passed the filtering are placed on the Event Attention Queue for delivery and viewing. The user can act on the active events via the Event View. For example, the user can click on a deal alert to shop online or to reserve a restaurant table by clicking on a birthday alert.

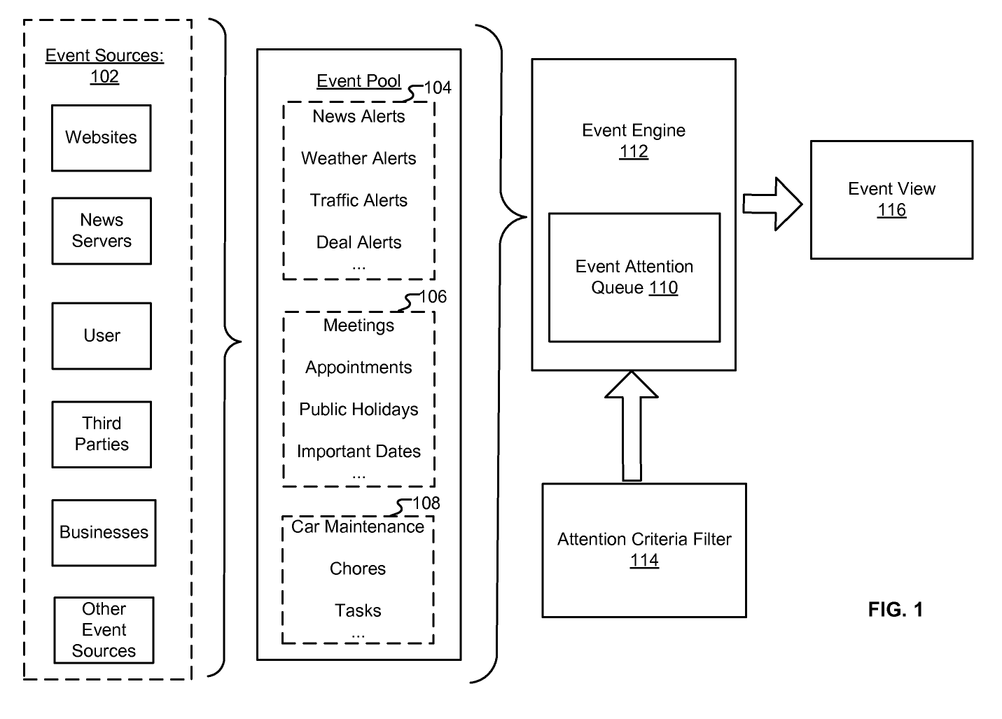

FIG. 1 shows an example schematic of the flow of event information from independent sources to an Event View. Independent sources 102 (e.g., news servers, websites, the user, third parties, businesses, and other event sources) provide information alerts 104 (fixed and flexible), fixed schedule events 106 (e.g., appointments, and important dates), and flexible schedule events 108 (e.g., tasks and chores) that go into an event pool. The information in the events are extracted and stored in an Event Attention Queue 110 by an Event Engine 112. The events can be further filtered by the Attention Criteria Filters 114 before they are placed on the Event Attention Queue 110 and/or the Event View 116. When an event becomes active, the Event Engine 112 lists the event in the Event View 116, delivers the Event View 116 for viewing by the user.

Conventionally, events can be delivered to the user as an undifferentiated list in the Event View. The list may be organized by priority or time of the events, but the interrelation between the events may not be explored or utilized. Shifting or rescheduling of the events is carried out by the user manually, and event by event. This is a time consuming and cumbersome process.

The following section describes an event bundling mechanism. In some implementations, the event bundling mechanism can include two steps: (1) activating “event bundling recommendations” and (2) event bundling.

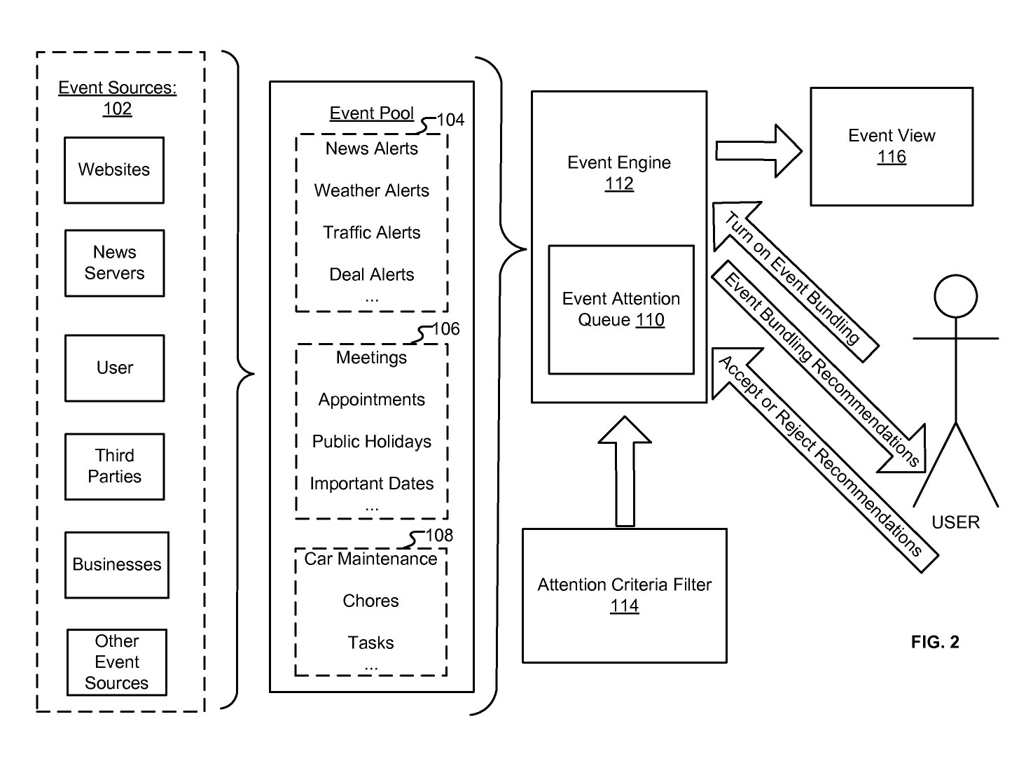

During the step for activating “event bundling recommendations,” the user decides whether to use the bundling process for event delivery and viewing. The Event Engine processes events in the Event Attention Queue and automatically recommends bundling of events that can be bundled. The user can accept or reject the recommendations. FIG. 2 is an example schematic diagram showing the interaction between a user and an Event Engine 112 regarding event bundling recommendations. First, the user elects to turn on the event bundling function. The Event Engine 112 receives notification that event bundling function has been turned on and automatically analyzes new and existing events in the Event Attention Queue 110 for potential bundling based on the Event Attention Criteria of the events. The Event Engine 112 then presents event bundling recommendations to the user in the Event View 116. The user can accept or reject the event bundling recommendations. The Event bundling recommendation can be done before any of the bundled events in the Event Attention Queue has become active. The bundling recommendations can be presented to the user for approval. Once the user has accepted the event bundling recommendations, the bundled events can become active at the times specified in the event bundling recommendations and be presented to the user.

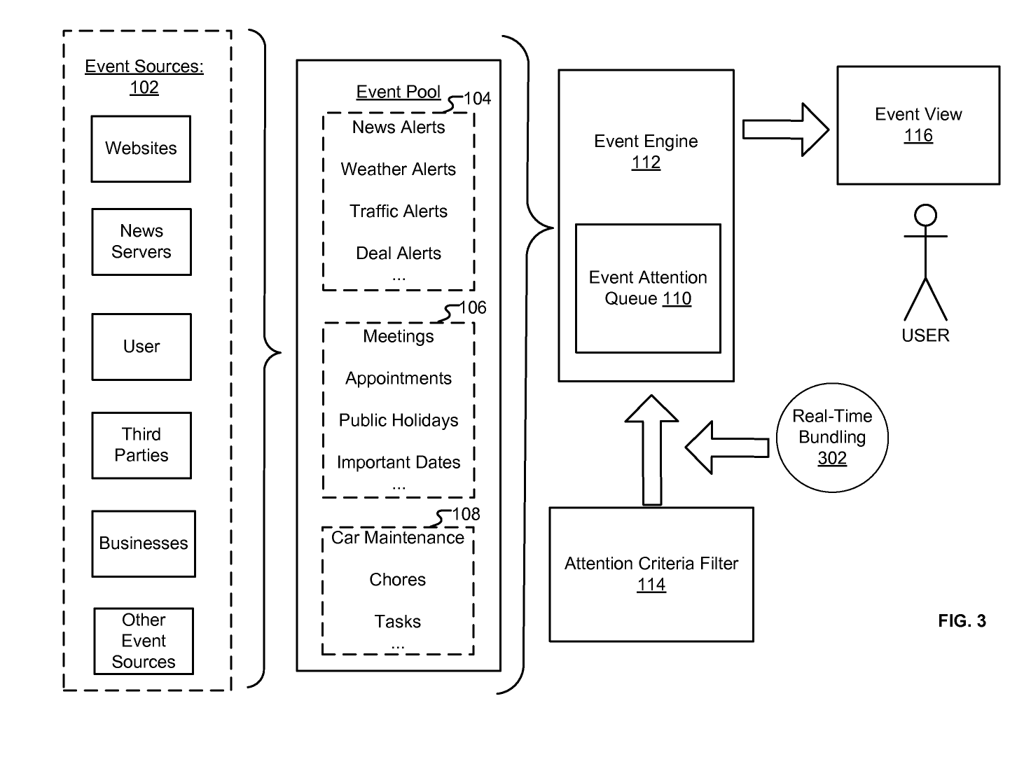

If the user has accepted bundling of certain events or types of events, these events (newly arrived or existing) can be automatically bundled in real-time during scheduling and/or delivery. FIG. 3 is an example schematic diagram showing the operation of the Event Engine for real-time event bundling. Events become ready for scheduling and/or delivery according to Event Attention Criteria associated with the Events. Events that have been marked for bundling cam be bundled according to their associated contexts and time windows (process 302). The event bundles can be placed in the Event Attention Queue 110 for delivery and viewing. When the events in the event bundles become active, the event bundles can be delivered to the user via the Event View 116.

The context and time window bundling process depends on the Event Attention Criteria associated with each event. The Event Attention Criteria can vary by event type and user preferences (each user can specify their specific preferences, a.k.a. personalization). The following table (Table (1)) provides an example of different events with Event Attention Criteria parameters.

TABLE 1

| | | Attention Time | Completion | Personal | Context/Event |
|---|---|---|---|---|---|
| Event Name | Type | Window | Window | Priority | Category |
| Traffic | Fixed | N/A | Short | High | Daily Exception |
| Exception | Alert | (Immediate) | | | Alert |
| Alert | | | | | |
| News-letter | Flexible | Long | Medium | Low | Info Alert |
| update Alert | Alert | | | | |
| General | Flexible | Medium | Medium | Medium | Info Alert |
| News Alert | Alert | | | | |
| Jill's | Fixed | N/A (Pre- | Long | High | Important Dates |
| Birthday | Schedule | determined) | | | |
| House | Flexible | Long | Long | Low | Chore |
| Maintenance | Schedule | | | | |
| Car | Flexible | Medium | Short | Medium | Chore |
| Maintenance | Schedule | | | | |
| (oil change) | | | | | |

Referring to Table 1, events can be associated with different event types. An event can be of type Information Alerts or Schedules. Alerts can be flexible alerts or fixed alerts. Schedules can be fixed or flexible schedules. For example, a user can subscribe to a traffic information alert for certain major highways in the user's area, and the traffic information alert is delivered to the user's email inbox whenever a traffic accident or traffic congestion occurs or clears on one or more of those major highways. Since these alerts are sent to the user by the server of the traffic information in real time as the traffic information becomes available, these alerts are referred to as fixed information alerts. Other fixed information alerts can include stock alerts, emergency weather alerts, and so on. A flexible information alert can be information delivered at a specified time, but the information can be held from the user for a period of time without impacting on the usefulness and timeliness of the information. Examples of flexible information alerts can be a newsletter, a job listing, a news feed, and so on. The user can specify whether certain information alerts are time-critical, and require delivery immediately as they become available. An information alert can be fixed or flexible depending on the user's specification.

Each event can also be associated with an Attention Time Window, or time window. The time window available for a flexible event extends for a period of time. The target (starting) time for a flexible event can be selected from anywhere within the time window. For example, a vehicle maintenance task can have an attention time window that last several weeks, and the user can choose to act on the task any time during those few weeks. In contrast, a fixed event has a fixed target (starting) time, and there is no flexibility in changing that fixed target (starting) time. For example, a dental appointment is made for a particular date and time, the user cannot unilaterally change the scheduled time. The user has to either go to the appointment as scheduled or reschedule the appointment with the doctor's office. Similarly, a fixed information alert has zero attention time window, and the target time for delivery of the fixed information alert is the time that the information alert becomes available (e.g., as the information alert is received from the server of the information). A flexible information alert can be delivered to the user during a period of time after the flexible information alert is received from the server of the information. The delayed delivery of the information alert to the user will not affect the usefulness and timeliness of the flexible information alert. For example, a newsletter from a user's alma mater can be delivered over the weekend for the user to read at his leisure even if the newsletter has been received by Event Engine during the week.

Each event can also be associated with a completion window. A completion window for an event indicates the period of time for completing the event once the event has started. For example, for a scheduled appointment, the completion window can be the duration of the appointment. For an information alert, the completion window can be the duration for a user to finish reading the information in the information alert. For a task (e.g., an assignment), the completion window can be the duration for a user to complete the assignment after the user has started on the assignment. The completion window can be long, medium, or short. The definition for a long, medium, or short window can be system or user defined. The user can also specify and adjust the exact size for the completion window for each event.

An event can also be associated with a personal priority. The user can define the priority for an event. The user specification can override the default priority set by the system. The Event Engine can use the priority attribute to determine the priority of the events within the Event Attention Queue. Priority can also be used to determine event bundling when scheduling conflicts occur during the bundling process.

An event can also be associated a context. Context can include information of any other variables that describe or categorize a particular event. For example, context for a task or scheduled event can include information on whether a particular event is an outdoor event or indoor event. The context can also include information on the location of the event. The context can include information on the category of the event, whether the event is a chore, a work assignment, a social event, a public event, a sporting event, and so on. The context for a task can include information regarding the necessary parties or prerequisites for accomplishing the task. For example, a car registration task may require a trip to the local Department of Motor Vehicles (DMV). The context information can include a requirement that this event cannot occur on a date on which the DMV is closed. The context can also include information on whether two events are related. For example, an outdoor event at a remote location may be related to a traffic information alert and a weather information alert. The relationship between events can be specified in the context as well.

Example values for each of the above Event Attention Criteria parameters are as follows: Attention Time Window for Alert Events can be minutes for Short, hours for Medium, and days for Long. Attention Time Window for Schedule Events can be days for Short, weeks for Medium, and months for Long. Completion Window for Alert Events can be a one-minute glance for Short, a 5- to 30-minute read for Medium, and over an hour-long read for Long. Completion Window for Schedule Events can be ¼ day for Short, ½ day for Medium, and 1 day+ for Long. Other denominations for time can be used, and each time window, completion window can be specified individually.

There are a multitude of other event examples that can be described in terms of the Attention Criteria table above. For example, National/Ethnic/Religious holidays, appointments, important dates (e.g: Valentine's Day, birthdays, anniversaries), deal alert, product update alert, blog alert, community updates alerts, automobile maintenance alerts etc. This list is by no means exhaustive, and many other types of events are possible.

Of particular interest are events that are flexible, e.g., not tied to fixed target dates. For example, a car maintenance task and a house maintenance task have flexible start dates within a period of time. In addition, events of type “Flexible Alerts” are flexible in terms of delivery time to the user. Flexible events (either flexible schedule events, or flexible information alerts) are amenable to bundling according to their Event Attention Criteria, namely, Type, Attention Time Window, Completion Window, Priority, and Context. The Attention Time Window is specified in relation to the target date and time for the event. The Attention Time Window specifies a time interval before and after the target date and time within which the target date and time can be shifted. The denomination for time (e.g., days, hours, minutes, etc.) is of no particular importance, and can be adjusted for each particular type of events.

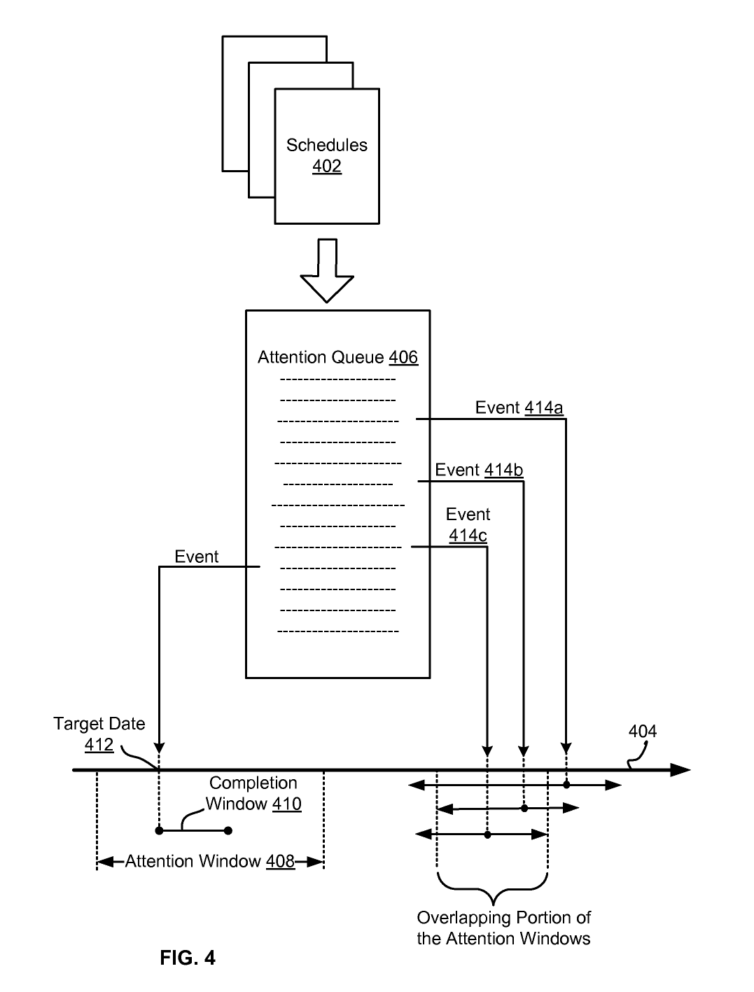

FIG. 4 is an example schematic diagram showing the process for organizing schedule events into a timeline. As shown in FIG. 4, any schedule holds a sequence of schedule events, ordered according to their respective target times on a timeline. The schedules 402 can include events added by the user, other users, and other different event sources. The timeline 404 may have a fixed start date (e.g. the first day of each month or week). The timeline 404 may also start from a time relative to the current day (e.g. 10 days ahead from today).

Each event can be named (e.g. “Valentine's Day”) and identifiable by its name. Each event can also be associated with a particular type, has a target date and time, an attention time window, a completion window, priority, and context. Context can also include event category. Examples of event categories include important dates (e.g: birthday), appointments, and tasks (e.g: chores), etc.

The attention time window can be of zero days length, which means no deviations from the target date/time is allowed. In other words, the schedule event has a fixed date/time. The time window can also be infinite, which means the schedule event can occur at any time.

The Even Attention Queue 406 is an aggregation of input from multiple, disparate event sources. Each source is independent of each other. The aggregation is an Event Attention Queue 406 with all events on one timeline 404.

Event information (context, priority, attention time window, completion window etc.) may be utilized to optimize the scheduling of events automatically. Each user has a unique Event Attention Queue, consisting of selected combinations of fixed and flexible events.

With all events, from disparate sources consolidated into one Event Attention Queue 406, each event can be compared and matched in relation to other events. Events that are of the same event category and related contexts (e.g., chores within reasonable location proximity), and have overlapping time windows can be bundled. Sometimes, event bundling can be limited such that the aggregated completion windows of each set of bundled events will fit into a predetermined time period (e.g., a day or 9 am-5 pm, and so on). In some implementations, relative priority of the events is also taken into consideration in event bundling. High priority events are not rescheduled to accommodate lower priority events if there is a scheduling conflict. If events are amendable to be bundled together, i.e., bundling will create convenience and save time, then the events can be moved within their respective time windows to be closer to one another (i.e., bundled).

FIG. 4 also shows that each schedule event has an attention time window 408, and a completion window 410 that falls within the attention window 408 following the target time 412 of the event. The target time 412 can be moved within the attention time window 408. Events with overlapping time windows (e.g., events 414a-c) can also exist in the Event Attention Queue 406.

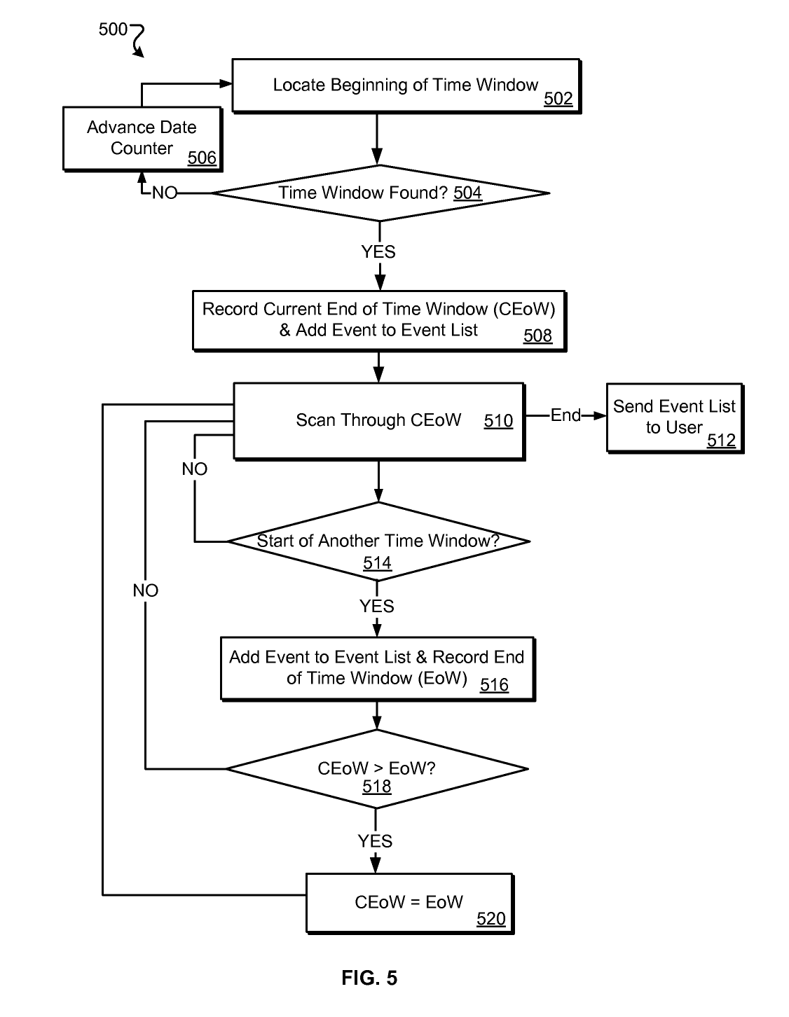

FIG. 5 illustrates an example process 500 of identifying events with overlapping time windows. The process can begin with a scan within the Event Attention Queue at some predefined time period ahead of the current date. The predetermined time period may be configurable by individual users but can also be set by the system to a default value (e.g., one week ahead of today's date).

The process can scan within a scan window on the timeline. The size of the scan window can be configured and have a default value as well (e.g., 4 weeks).

Within the scan window, the process searches for the start of a time window that belongs to an event in the Event Attention Queue (502). If the window is not found within a unit of time (e.g., 1 day) (504), the date counter is incremented (506), and the scan continues along the timeline. Once the start of a time window for an event is found (504), the process records the end of the time window as the Current End of Window (CEoW) and adds the event to an event list (508). The process continues to scan towards the CEoW (510). If no other event is found before the CEoW is reached (514), the scan is completed and the event(s) in the event list is sent to another process (512). If another event is found before the CEoW is reached (514), the newly found event is added to the event list and the time window of the newly found event is examined (516). If the newly found event has an end of its time window (End of Window—EoW) earlier than CEoW (518), then the EoW of the newly found event is set as the CEoW (520). This resetting of the CEoW ensures that time windows of the events in the event list remain overlapping through this process. The process continues to scan through the CEoW (510). Upon reaching the CEoW, the process will pass control to another process that processes the event list to present to a user (512).

This process 500 can be further refined by taking other event attributes in the Event Attention Criteria into consideration. If an event has an event type or context that is incompatible with the events already in the event list, the event can be ignored and not added to the event list. This would avoid an artificially narrow time window caused by a time window from an incompatible event. For example, if two events' time windows only overlap by a short period of time, and neither event can be completed within that overlapping portion, then these two events are incompatible events, and should not be added to the event list together. In addition, certain event categories benefit from bundling (e.g. chores), while others do not (e.g. Holidays). Events associated with different locations may merit further analysis prior to being bundled. For example, events that occur at locations along a route can be scheduled in an order so that the least amount of distance is traveled to accommodate all of those events. For another example, some events occur at such different locations that they cannot be realistically accomplished within their overlapping time window due to the travel time involved. Such events are incompatible events and should not be bundled together.

As an example, chores are typically flexible schedule events and would benefit from bundling. It may save a user time to move chores to one single day instead of spreading them out to many days. For another example, information alerts from disparate information notification services can be bundle into one event view for a bundled and customized delivery to the user. The bundled delivery of non-critical information alerts can save time and remove information clutter for the user.

The opportunity to bundle tasks is discovered automatically and can be presented as an option to a user ahead of time. The user can confirm or reject the event bundling recommendations.

Event bundling can be executed using an automated process. The events are bound in time with some timing flexibility expressed by the size of the attention time window. The method is predictive since it will only bundle events of types that are flexible (moveable) and hence suitable for bundling. Event bundling can take into consideration factors including event type, attention time window, completion window, priority, and contexts. Events can be bundled if they have overlapping time windows. The new target times for the bundled events will fall within the overlapping portion of the events' respective time windows. In some implementations, bundling requires that the aggregated completion windows for the bundled events fit within a day or specified unit of time.

While events of identical type (e.g. chores) can be bundled, it is also possible to define relationships between events based on context. For example, an outdoor alert event (e.g. weather alert, traffic alert, or natural disaster alert) can be related to outdoor chore events (e.g. house maintenance, car maintenance, and so on). When related events overlap, they too can be bundled. Relationships between events can be explicitly set up by a user. For example, the user can specify in the events' contexts that the events are related to other events, other types of events, or events with certain context information. For another example, relationships between events can be identified by the semantics or key words in the events' contexts and/or the information in information alerts.

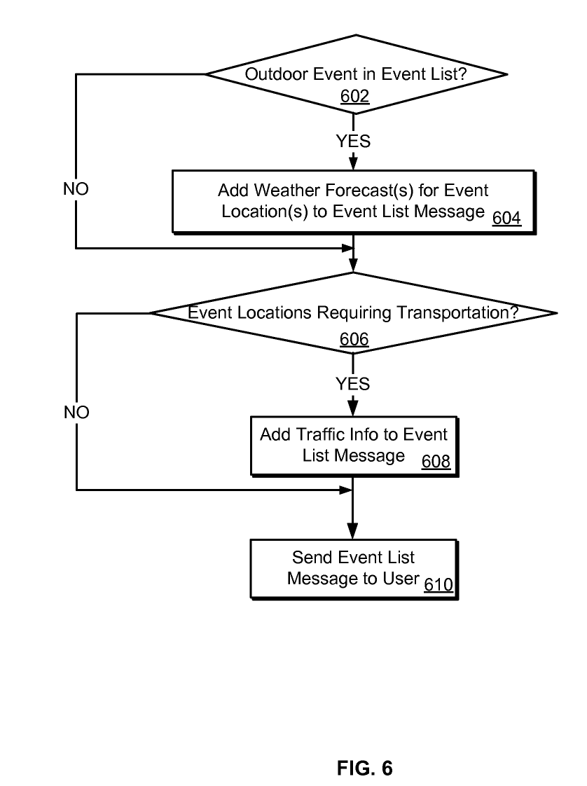

Event bundling can be further expanded to include bundling of context-based information with events. FIG. 6 is a flow chart illustrating an example process 600 for bundling events with weather information and traffic information. For example, if an event is associated with an outdoor context (602), and the context includes location information for the event, weather forecast information for the location can be added to the event in the event list message (604). If it is determined that the event location is remote to the user's default location and requires transportation (606), traffic information to the associated locations can be added to the event list message (608). Then the event list message can be sent to the user (e.g., in the Event View) (610). If the event bundle is displayed to the user ahead of the actual start date of the first bundled event, real-time traffic information would not be required. A weather forecast for the start date may be included. On the actual start date of the event, the event bundle can be sent with real-time weather and traffic information.

Schedule and task-list optimization across multiple users is also possible. Multiple schedules and task-lists from different users can be processed through the context and time window bundling process for optimization. This multi-user event bundling is especially effective for a group of users that have some mutual dependency defined by their relationship, such as family members, office department group or, social group (e.g. local book club). The event bundling can be used to improve coordination and cooperation among the group of users.

The following disclosure includes a number of use case examples for event bundling.

Use Case #1—Bundling of Chores for a Single User:

In this example, a user subscribes to a house maintenance schedule, a car maintenance schedule and a U.S. Holidays schedule. These are all disparate schedules that are entered into the Event Attention Queue. The schedules hold scheduled appointments, important dates, tasks, and chores. For one particular day, the schedules identify a car service event, a water heater service event, and a one-week-to-Valentine's-Day event, which have overlapping time windows. The events also belong to the same event category (i.e., chores). The overlapping events are bundled to a single day and sent to the user as a single task list message. The user can get the single task list for the single day and get all chores out of the way to free up days before and on the Valentine's Day.

Use Case #2—Combining Chores and other Related Events:

In this example, a user subscribes to a house maintenance schedule and a car maintenance schedule. These are disparate schedules that have been entered into the Event Attention Queue. On one particular day, the schedules identify a car service event and a garden maintenance event, both with overlapping time windows. The events belong to the same event category (i.e., chores) and have an outdoor context. The overlapping events are bundled to one day and sent to the person as a single task list message. If the user also subscribes to weather and traffic alerts, weather information and traffic information are included in the task list as additional information since weather and traffic information is related to outdoor activities.

Use Case #3—Cross-User Optimization and Communication:

In this example, a parent (husband) subscribes to a house maintenance schedule and a car maintenance schedule. These disparate schedules are entered into the Event Attention Queue for the parent. On one particular day, the schedules identify a car service event and a garden maintenance event, both with overlapping time windows. The two events belong to the same event category (i.e., chores). The overlapping events are bundled to one day and sent to the husband as a single task list message. Since the husband has a defined relationship with another user (i.e., the wife) as can be expressed in the settings of the Event Engines of both users, the other user (i.e., the wife) also receives the same task list. Both the husband and the wife are offered with the option to reject or accept the task list for the proposed date. If both users accept the task list, they can selectively assign tasks to themselves. If either user rejects the task list, a coordination process begins. The event engine can generate a message requesting another proposed date within the given time window. One user can choose a suitable date or defer the decision to the other user. The information accompanying the acceptance and/or rejection can be used to adjust the schedules of both users to optimize time saving and convenience. Once an agreed new target date has been established, the new target date is associated with the events, and the events are entered into the Event Attention Queue with the new target date. When the events become active, they will be presented to the user that has accepted the event previously.

Use Case #4—Combining Flexible Alerts:

In this example, a user subscribes to multiple information alerts including a newsletter update, a competitive intelligence report and a software driver update. All these alerts are flexible and do not require the user's immediate attention. If all of these alerts become active (e.g., they were received as emails from the servers of the information) in one particular week. The system using the configured attention criteria bundles all these updates and delivers the single information bundle for user to read over the weekend.

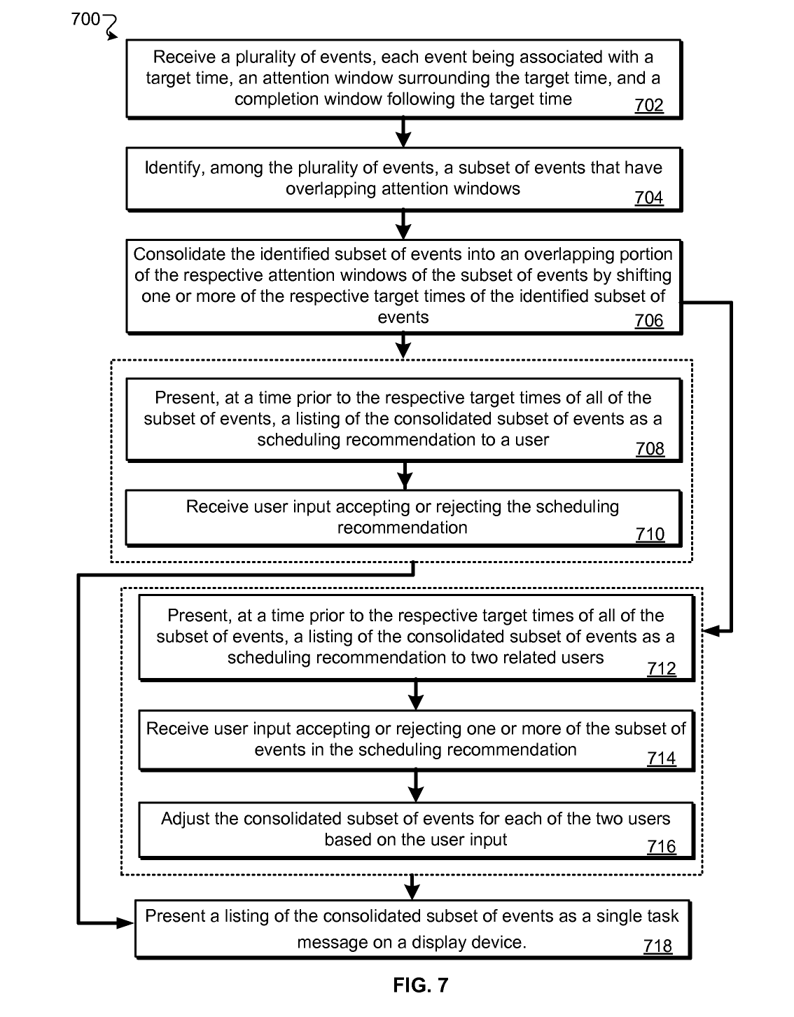

FIG. 7 is a flow chart illustrating an example process 700 for event bundling and delivery. The process can start when a plurality of events are received (702). Each of the plurality of events can be associated with a target time, an attention window surrounding the target time, and a completion window following the target time. The target time for a fixed schedule event can be defined as a time at which the event is scheduled and needs to be carried out. The target time for a flexible schedule event can be defined as a time within the attention window, and a time at which the flexible schedule event can be carried out. Target time for information alerts can be defined as the time that an information alert should be delivered to the user. For some information alerts, the target time can be defined as the time that the information alert is available. The completion window of a schedule event can be defined as the time needed for a user to complete the event (e.g., task or chore) once it is started. The completion window for an information alert can be defined as the time needed for a user to finish reading the information in the information alert.

The plurality of events can be stored in an event pool which holds all of the events received from different sources. Typically, the event sources are independent sources and do not coordinate with one another when delivering the events to the event pool.

The process continues when a subset of events are identified among the plurality of events (704). The subset of events can have overlapping attention windows. The identification of events with overlapping attention windows can be carried out according to the method described with respect to FIG. 5. Identification of events with overlapping attention windows can also take other factors into consideration, such as the compatibility of the event categories, the amount of overlapping, conflicting priorities, and so on.

After the subset of events with overlapping attention windows are identified, the identified subset of events can be consolidated into an overlapping portion of the respective attention windows of the subset of events (704). The consolidation can be done by shifting one or more of the respective target times of the identified subset of events. The consolidation of the subset of events can be refined by limiting the number of events that can be consolidated into a single day. For example, the consolidation can pack as many events into a continuous time segment within the overlapping portion of the attention windows, and it can also take into consideration of the rest time, travel time in between events.

The plurality of events can include fixed events having fixed target times and flexible events having movable target times within the flexible events' respective attention windows. The plurality of events can include information alerts, date alerts, tasks, and appointments, each having either a fixed target time or a moveable target time within the event's respective attention window.

In some implementations, each of the plurality of events is further associated with a respective event category. Event category describes the type of the event. Examples of event categories include chores, tasks, work assignments, birthday, anniversary, holiday, vacation, newsletter, traffic alert, weather alert, deal alert, and so on. In some implementations, the identification of the subset of the plurality of events not only takes into consideration the overlapping attention window, but also the compatibility of the event categories. Therefore, the identification of the subset of events includes identifying the subset of events having overlapping attention windows that are associated with compatible event categories. Compatibility of event categories can be determined based on the user preference or the default system settings. For example, chores are typically compatible with other chores, and they can be bundled together to save time. For another example, some chores (e.g., a car registration event or a work assignment) may not be compatible with certain important dates (e.g., a public holiday or a weekend). For another example, a shopping trip can be compatible with a visit to friend, but a shopping trip may not be compatible with a job interview.

In some implementations, each of the plurality of events is further associated with a respective context. The context can include any kind of information that may be used to determine whether bundling may be helpful and acceptable. For example, the context can include location information of the event. The context of an event can also include information on the relationship of the event with other events, other types of events, or people that are involved in the event, and so on. The context of an event (e.g., a task) can also include the necessary preparation or prerequisites for completing the event. When taking into consideration of the context of events for bundling, identifying the subset of events can further include identifying the subset of events having overlapping attention windows and being associated with compatible contexts. In some implementations, the respective context of each of the plurality of events includes location information for the event, and compatibility of events is based on the location information. For example, two events are compatible if the location of each event is in close proximity to each other. Two events are not compatible if the locations associated with the two events are too far apart from each other such that travelling between the locations would take too much time.

In some implementations, each of the plurality of events is further associated a respective event category and a respective context, and at least some of the plurality of events are related events based on the events' respective event categories and contexts. Identifying the subset of events for bundling further includes identifying, among the plurality of events, the subset of events having overlapping attention windows and being related events to one another. For example, a gardening chore (e.g., weeding) is a chore that has an outdoor context. The gardening chore can be a related event to another gardening chore (e.g., pruning). These two gardening chores are related because their locations are the same, and the weeds and trigs can be sent to the composter together after the weeding and the pruning. These two gardening can further be related to a weather information alert because weather information alert can also be associated with an outdoor context. The weather information can be bundled with the gardening chores as well. For another example, an off-location task (e.g., a job interview at a remote location, or a shopping trip at a remote shopping center) can be related to a traffic information alert. The context information of the off-location tasks can include the specific location of the destinations, and the traffic information alert can be tailored to those specific locations.

In some implementations, when consolidating the identified subset of events into the overlapping portion of the respective attention windows of the subset of events, the overlapping portion of the respective attention windows is divided into two or more segments if the overlapping portion exceeds a predetermined duration. For example, if the overlapping portion of the attention windows for several events is more than one day long, then the overlapping portion can be divided into two or more segments of one-day duration. The subset of events can be consolidated into the two or more segments by shifting one or more of the respective target times of the identified subset of events. The aggregated completion windows of the events consolidated into each segment is required to fit within the segment.

In some implementations, at a time prior to the respective target times of all of the subset of events, a listing of the consolidated subset of events can be presented as a scheduling recommendation to a user (708). User input can be received accepting or rejecting the scheduling recommendation (710). In some implementations, a listing of the consolidated subset of events is presented as a single task message on a display device (718). The listing of the consolidated subset of events can be presented when one of the consolidated subset of events becomes active (e.g., when the event's target time after the consolidation is reached).

In some implementations, at a time prior to the respective target times of all of the subset of events, a listing of the consolidated subset of events can be presented as a scheduling recommendation to two related users (712). User input accepting or rejecting one or more of the subset of events in the scheduling recommendation can be received (714). The consolidated subset of events for each of the two users can be adjusted based on the user input (716).

In some implementations, the subset of events include flexible information alerts, and a listing of the consolidated subset of flexible information alerts are presented as a single information alert message.

In summary, multiple disparate schedules, tasks-lists and information update alerts can be correlated for the purpose of identifying events that can be combined (bundled) into one time window. By bundling events, a person can better schedule his/her time without having to proactively examine and coordinate manually. By assigning an event type, priority, context (e.g., location), time window and completion window to each event, the system can intelligently make bundling decisions.

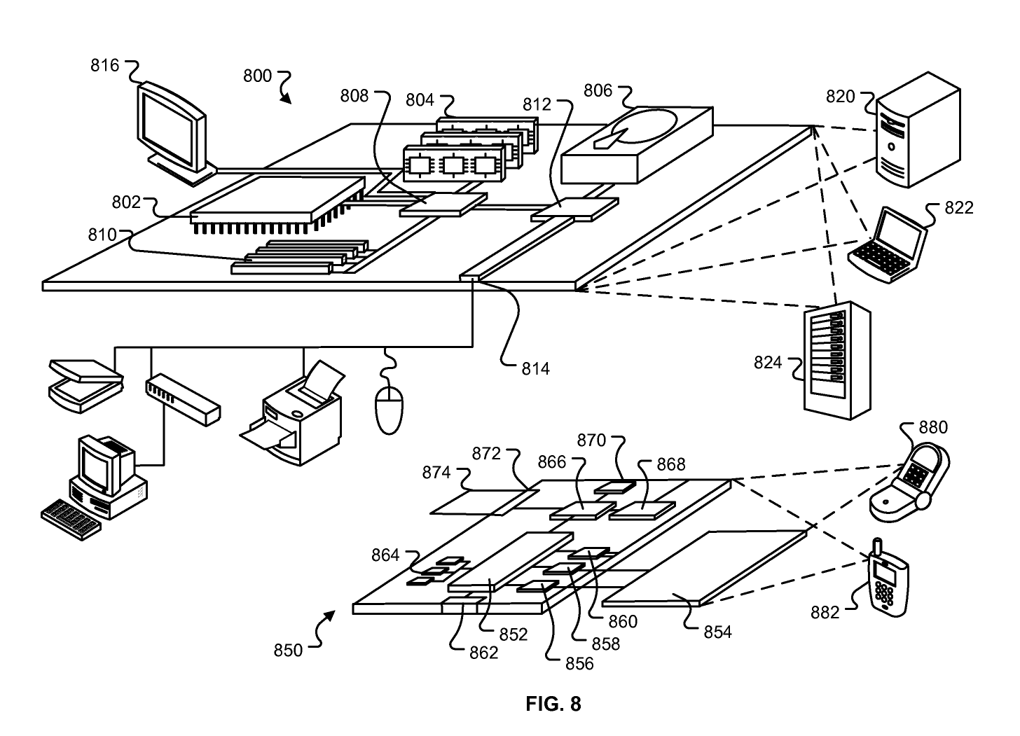

FIG. 8 is a block diagram of computing devices 800, 850 that may be used to implement the systems and methods described in this document, as either a client or as a server or plurality of client and servers. Computing device 800 is intended to represent various forms of digital computers, such as laptops, desktops, workstations, personal digital assistants, servers, blade servers, mainframes, and other appropriate computers, etc. Computing device 850 is intended to represent various forms of mobile devices, such as personal digital assistants, cellular telephones, smartphones, and other similar computing devices. The components shown here, their connections, relationships, and functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. Instructions can include those for operating the Event Engine. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a computer-readable medium. In one implementation, the memory 804 is a volatile memory unit or units. In another implementation, the memory 804 is a non-volatile memory unit or units.

The storage device 806 is capable of providing mass storage for the computing device 800. In one implementation, the storage device 806 is a computer-readable medium. In various different implementations, the storage device 806 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of duties is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can process instructions for execution within the computing device 850, including instructions stored in the memory 864. The processor may also include separate analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD display or an OLED display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication (e.g., via a docking procedure) or for wireless communication (e.g., via Bluetooth or other such technologies).

The memory 864 stores information within the computing device 850. In one implementation, the memory 864 is a computer-readable medium. In one implementation, the memory 864 is a volatile memory unit or units. In another implementation, the memory 864 is a non-volatile memory unit or units. Expansion memory 874 may also be provided and connected to device 850 through expansion interface 872, which may include, for example, a SIMM card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS receiver module 870 may provide additional wireless data to device 850, which may be used as appropriate by applications running on device 850.

Device 850 may also communication audibly using audio codec 860, which may receive spoken information from a user and convert it to usable digital information. Audio codex 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the search systems and methods have been described, it should be recognized that numerous other applications are contemplated. While reference is made to determining hierarchical data associated with a resource determined as a search result, hierarchical data can be associated with a resource identified by other means. For example, hierarchical data can be determined for a resource and associated with that resource, where a visual representation of the hierarchical data can be attached to the resource for display to a user in an email message. The resource may be the result of a request made by a user to customer service support on a web site for specific information included on the web site. Accordingly, other embodiments are within the scope of the following claims.

What is claimed is:

1. A computer-implemented method, comprising:
receiving a plurality of events on a computing device, each event being associated with a target time, an attention window surrounding the target time, and a completion window following the target time;
identifying, among the plurality of events, a subset of events that have overlapping attention windows; and
consolidating the identified subset of events into an overlapping portion of the respective attention windows of the subset of events by shifting one or more of the respective target times of the identified subset of events.

2. The method of claim 1, wherein the plurality of events are from a plurality of independent sources.

3. The method of claim 1, wherein the plurality of events include fixed events having fixed target times and flexible events having movable target times within the flexible events' respective attention windows.

4. The method of claim 1, wherein the plurality of events include at least one of information alerts, date alerts, tasks, and appointments, each having either a fixed target time or a moveable target time within the event's respective attention window.

5. The method of claim 1, wherein each of the plurality of events is further associated with a respective event category, and wherein identifying the subset of events further comprises:
identifying, among the plurality of events, the subset of events having overlapping attention windows and being associated with compatible event categories.

6. The method of claim 1, wherein each of the plurality of events is further associated with a respective context, and wherein identifying the subset of events further comprises:
identifying, among the plurality of events, the subset of events having overlapping attention windows and being associated with compatible contexts.

7. The method of claim 6, wherein the respective context of each of the plurality of events includes location information for the event, and compatibility of events is based on the location information.

8. The method of claim 1, wherein each of the plurality of events is further associated with a respective event category and a respective context, and at least some of the plurality of events are related events based on the events' respective event categories and contexts, and wherein identifying the subset of events further comprises:
identifying, among the plurality of events, the subset of events having overlapping attention windows and being related events to one another.

9. The method of claim 8, wherein a pair of related events includes an outdoor task and a weather information alert, or an off-location task and a traffic information alert.

10. The method of claim 1, further comprising:
presenting, at a time prior to the respective target times of all of the subset of events, a listing of the consolidated subset of events as a scheduling recommendation to a user; and
receiving user input accepting or rejecting the scheduling recommendation.

11. The method of claim 1, further comprising:
presenting, at a time prior to the respective target times of all of the subset of events, a listing of the consolidated subset of events as a scheduling recommendation to two related users;
receiving user input accepting or rejecting one or more of the subset of events in the scheduling recommendation; and
adjusting the consolidated subset of events for each of the two users based on the user input.

12. The method of claim 1, further comprising:
presenting a listing of the consolidated subset of events as a single task message on a display device.

13. The method of claim 1, wherein the subset of events include flexible information alerts, and a listing of the consolidated subset of flexible information alerts are presented as a single information alert message.

14. A computer-readable medium having instructions stored thereon, which, when executed by at least one processor, cause the processor to perform operations comprising:
receiving a plurality of events, each event being associated with a target time, an attention window surrounding the target time, and a completion window following the target time;
identifying, among the plurality of events, a subset of events that have overlapping attention windows; and
consolidating the identified subset of events into an overlapping portion of the respective attention windows of the subset of events by shifting one or more of the respective target times of the identified subset of events.

15. The computer-readable medium of claim 14, wherein each of the plurality of events is further associated with a respective event category, and wherein identifying the subset of events further comprises:
identifying, among the plurality of events, the subset of events having overlapping attention windows and being associated with compatible event categories.

16. The computer-readable medium of claim 14, wherein each of the plurality of events is further associated with a respective event category and a respective context, and at least some of the plurality of events are related events based on the events' respective event categories and contexts, and wherein identifying the subset of events further comprises:
identifying, among the plurality of events, the subset of events having overlapping attention windows and being related events to one another.

17. The method of claim 14, wherein the instructions further comprises:
presenting, at a time prior to the respective target times of all of the subset of events, a listing of the consolidated subset of events as a scheduling recommendation to a user; and
receiving user input accepting or rejecting the scheduling recommendation.

18. A system comprising:
one or more processors;
memory coupled to the one or more processors and operable for storing instructions, which, when executed by the one or more processors, cause the one or more processors to perform operations, comprising:
receiving a plurality of events, each event being associated with a target time, an attention window surrounding the target time, and a completion window following the target time;
identifying, among the plurality of events, a subset of events that have overlapping attention windows; and
consolidating the identified subset of events into an overlapping portion of the respective attention windows of the subset of events by shifting one or more of the respective target times of the identified subset of events.

19. The system of claim 18, wherein each of the plurality of events is further associated with a respective event category, and wherein identifying the subset of events further comprises:
identifying, among the plurality of events, the subset of events having overlapping attention windows and being associated with compatible event categories.

20. The system of claim 18, wherein each of the plurality of events is further associated with a respective event category and a respective context, and at least some of the plurality of events are related events based on the events' respective event categories and contexts, and wherein identifying the subset of events further comprises:
identifying, among the plurality of events, the subset of events having overlapping attention windows and being related events to one another.
